(19) United States
(12) Patent Application Publication
(10) Pub. No.: US 2005/0249247 A1
(43) Pub. Date: Nov. 10, 2005

(54) Methods and apparatus for multiplexing multiple signal sources over a single full duplex ETHERNET link

(75) Inventors: Timothy M. Shanley, Orange, CT (US); Robert W. Hamlin, Monroe, CT (US); Jimmy Philip Ervin, Raleigh, NC (US)

Correspondence Address: Gordon & Jacobson, P.C., 65 Woods End Road, Stamford, CT, 06905, US

(73) Assignees: TranSwitch Corporation; Cisco Technology, Inc.

(21) Appl. No.: 10/839,001

(22) Filed: May 5, 2004

(51) Int. Cl. H04J 3/02

(52) U.S. Cl. 370/537; 370/474

(57) ABSTRACT

Methods for multiplexing multiple signal streams over a single full duplex ETHERNET link include modifying a standard ETHERNET packet header to indicate the stream to which the packet belongs. According to the presently preferred embodiments, the packet header is modified in a way which is well formed and does not cause framing errors in existing equipment. The methods of the invention may be carried out in existing ETHERNET framers/mappers with only a software modification. Thus, the new functionality can be obtained with existing equipment.

### BACKGROUND OF THE INVENTION

1. Field of the Invention

This invention relates broadly to telecommunications. More particularly, this invention relates to methods and apparatus for multiplexing multiple SONET signal streams over a single full duplex ETHERNET link.

2. State of the Art

The TRANSWITCH ETHERMAP-12 is a highly integrated OC-12 mapper for carrying ETHERNET traffic over SONET/SDH networks utilizing Virtual Concatenation (VCAT). It supports STM-4/STS-12/STS-12c rates using a parallel telecom bus operating at 77.76 MHz. The device supports up to eight 10 Mbps or 100 Mbps ETHERNET ports using the SMII interface standard or a single Gigabit (1,000 Mbps) ETHERNET port using the GMII interface standard.

When the ETHERMAP-12 is operated in the SMII mode, eight FIFOs are provided, one for each ETHERNET port, each ETHERNET port being associated with one SONET port, virtual port or virtual concatenated group (VCG). Each FIFO has a high and a low threshold point which are associated with defined Xon (transmit data on) and Xoff (transmit data off) conditions. When a FIFO exceeds the Xoff threshold, a pause frame is generated. The pause duration is programmable and is identified in the pause frame. When the FIFO re-crosses the Xon threshold, a pause frame with a very short pause duration is generated. When operated in the SMII mode, the ETHERMAP-12 can support an OC-3 ring (155 Mbps) by combining two of the eight ETHERNET ports.

When the ETHERMAP-12 is operated in Gigabit mode, a single FIFO is provided for the single Gigabit ETHERNET port. In this mode, the ETHERMAP-12 supports a single OC-12 ring (622 Mbps). It would be desirable to multiplex a plurality of SONET ports, virtual ports or virtual concatenated groups (VCGs) over the single Gigabit ETHERNET link. For example, it would be desirable to support multiple OC-3 rings in the Gigabit mode of the ETHERMAP-12.

### SUMMARY OF THE INVENTION

It is therefore an object of the invention to provide methods and apparatus for multiplexing multiple signal sources over a single full duplex ETHERNET link.

It is another object of the invention to provide methods for multiplexing multiple signal sources over a single full duplex ETHERNET link using existing equipment.

It is a further object of the invention to provide methods for multiplexing multiple signal sources over a single full duplex ETHERNET link using an ETHERMAP-12 chipset.

It is also an object of the invention to provide methods for multiplexing a plurality of SONET ports over a single full duplex ETHERNET link using existing equipment.

It is an additional object of the invention to provide methods for multiplexing a plurality of SONET signal sources over a single full duplex gigabit ETHERNET link.

It is still another object of the invention to provide methods for multiplexing a plurality of SONET signal sources over a single full duplex gigabit ETHERNET link using existing equipment.

In accord with these objects, which will be discussed in detail below, methods for multiplexing multiple signal streams over a single full duplex ETHERNET link include modifying a standard ETHERNET packet header to indicate the stream to which the packet belongs. According to the presently preferred embodiments, the packet header is modified in a way which is “well formed”, i.e. it does not cause framing errors in existing equipment because of an incorrect length, for example. The methods of the invention may be carried out in existing ETHERNET framers/mappers with only a software modification. Thus, the new functionality can be obtained with existing equipment.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram illustrating bi-directional operation of the invention;

FIG. 2A is an illustration of a prior art PDU MAC Encapsulation format;

FIG. 2B is an illustration of a modified PDU MAC Encapsulation format according to a first embodiment of the invention;

FIG. 2C is an illustration of a modified PDU MAC Encapsulation format according to a second embodiment of the invention;

FIG. 2D is an illustration of a modified PDU MAC Encapsulation format according to a third embodiment of the invention;

FIG. 3 is a more detailed illustration of the modified PDU MAC Encapsulation format according to the first embodiment of the invention;

FIG. 4 is a more detailed illustration of the modified PDU MAC Encapsulation format according to the second embodiment of the invention; and

FIG. 5 is a more detailed illustration of the modified PDU MAC Encapsulation format according to the third embodiment of the invention.

### DETAILED DESCRIPTION OF THE PREFERRED EMBODIMENTS

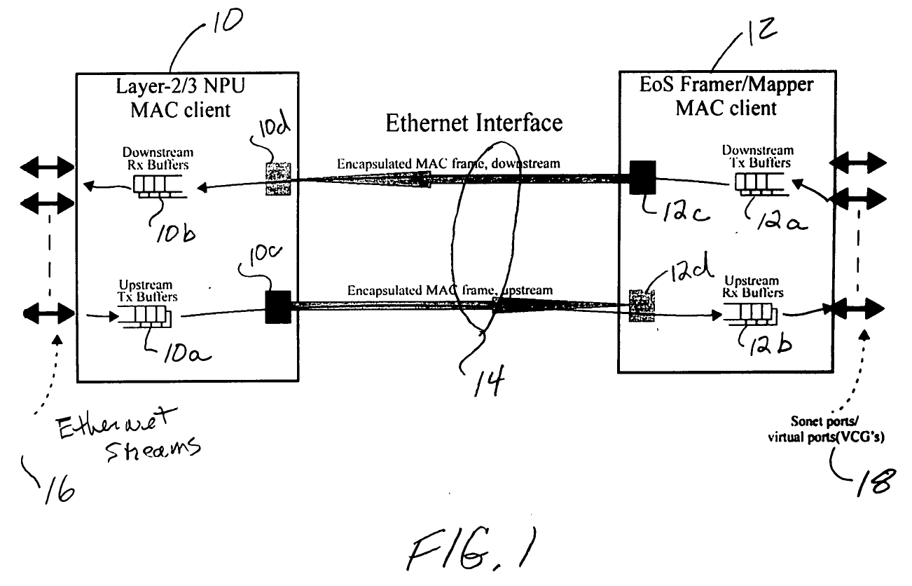

Turning now to FIG. 1, the invention is illustrated in a high level form with reference to a Layer 2/3 NPU (network processing unit) MAC (media access control) client 10 and an ETHERNET over SONET (EoS) framer/mapper MAC client 12. It will be appreciated, however, that the ETHERNET side of the arrangement need not be an NPU but could be any ETHERNET device including a router, bridge, etc. The clients 10, 12 are coupled to each other by a full duplex gigabit ETHERNET link 14. As illustrated in FIG. 1, traffic from left to right is considered to be upstream from a plurality of ETHERNET ports 16 to a plurality of SONET ports or VCGs 18. Traffic from right to left is considered to be downstream. Thus, the client 10 is provided with a plurality of upstream transmit buffers 10a (usually one for each data stream), a plurality of downstream receive buffers 10b, an upstream transmit addressing and scheduling module 10c, and a downstream receive addressing module 10d. Similarly, the client 12 is provided with a plurality of downstream transmit buffers 12a, a plurality of upstream receive buffers 12b, a downstream transmit addressing and scheduling module 12c, and an upstream receive addressing module 12d. Although FIG. 1 suggests a one-to-one correspondence in the number of upstream and downstream buffers, many different buffering techniques could be used in conjunction with the invention. FIG. 1 is merely an abstract illustration of buffers, not of any particular kind of buffers.

According to the invention, packets received from the ETHERNET ports 16 are placed in the upstream transmit buffers 10a. The upstream transmit addressing and scheduling module 10c receives a packet from one of the buffers 10a and encapsulates it in a modified MAC frame which includes an identification of which one of the destination ports 18 should receive the packet. The upstream receive addressing module 12d receives the MAC frame, decapsulates the packet and places the packet in one of the buffers 12b which corresponds to the destination port. Data traffic flow in the downstream direction operates in a similar manner. Packets received from the SONET ports 18 are placed in downstream transmit buffers 12a (one for each SONET port). These packets are each encapsulated by the downstream transmit addressing and scheduling module 12c in a modified MAC frame which includes an identification of which one of the SONET VCGs sourced the packet. The downstream receive addressing module 10d receives the MAC frame, optionally decapsulates the packet, and places the packet in one of the buffers 10b.

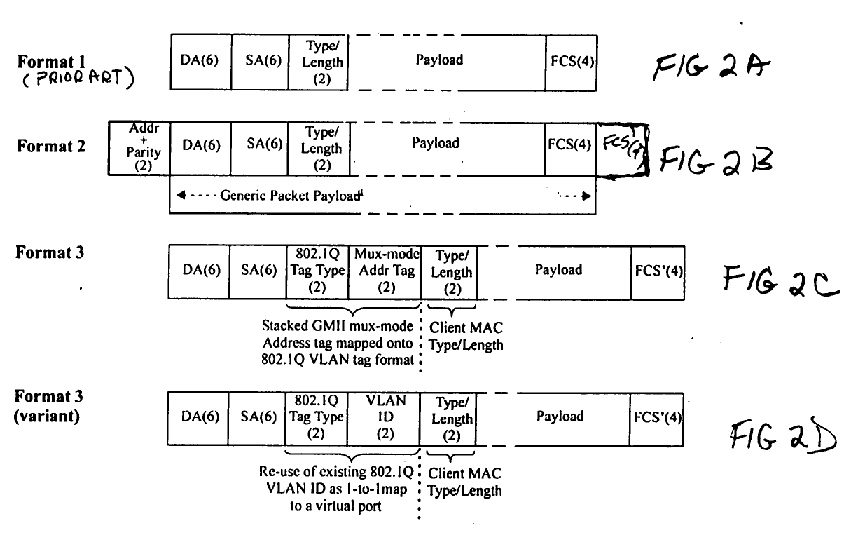

An important feature of the invention is the modified MAC frame. FIG. 2A shows a standard gigabit ETHERNET MAC frame. It includes a six byte destination address DA, a six byte source address SA, a two byte Type/Length indicator, a variable length Payload, and a four byte frame check sum FCS which protects from the destination address through the end of the packet payload.

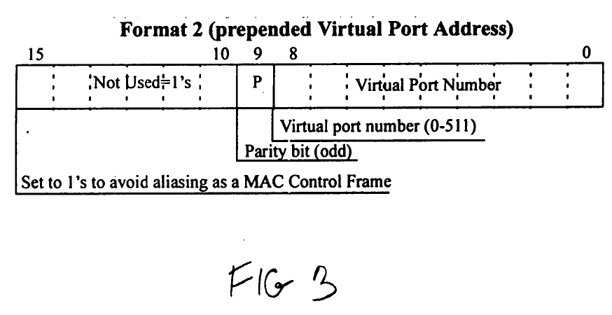

According to a first embodiment of the invention, a two byte address and parity indicator is pre-pended to the MAC frame and an additional four byte frame check sum FCS′ is appended to the MAC frame as shown in FIG. 2B. According to this embodiment, the address tag is nine bits LSB justified and optionally protected by an odd parity bit. The addition of the FCS′ field allows this format to be “well formed” and recognized as a normal MAC frame at the receiving MAC interface. FIG. 3 more clearly illustrates the arrangement of address bits for this embodiment. Bits 15-10 are set to ones so that the frame does not appear as a MAC control frame. Bit 9 is the optional odd parity bit and bits 8-0 are the virtual port number.

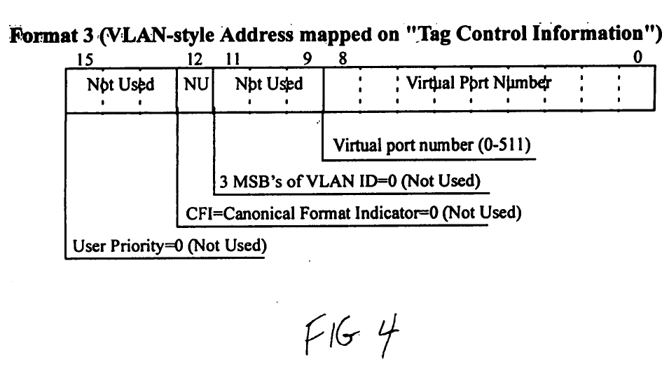

According to a second embodiment, the address tag is mapped onto a standard (IEEE 802.1Q) VLAN stacked label. In this embodiment, which is illustrated in FIG. 2C, the frame check sum bytes reflect the additional VLAN fields. FIG. 4 more clearly illustrates the arrangement of bits for this embodiment. Bits 15-9 are set to zeros and bits 8-0 are used for the virtual port number.

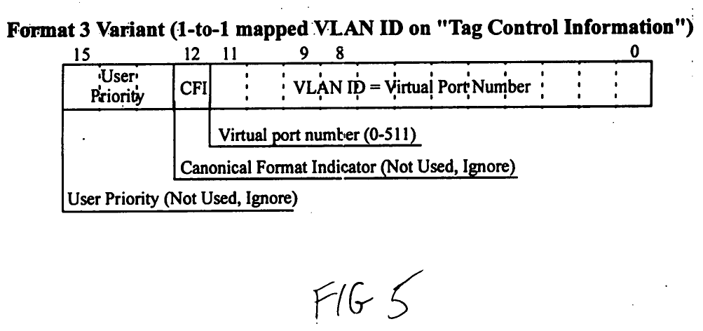

A variant of the embodiment is shown in FIG. 2D wherein an existing VLAN ID in the frame is mapped to a virtual port address. This variant can only be used where there is a 1:1 correspondence between VLAN IDs and virtual port addresses. Both of these addressing methods (i.e. the embodiments of FIGS. 2C and 2D) are well-formed and will not produce errors at the receiving MAC interface. FIG. 5 more clearly illustrates the bits of the VLAN ID which are mapped to a virtual port address. Bits 15-12 are ignored and bits 11-0 are mapped to a virtual port number. Since this variant uses an existing field, encapsulation/decapsulation is not needed.

There have been described and illustrated herein several embodiments of methods and apparatus for multiplexing multiple signal sources over a single full duplex ETHERNET link. While particular embodiments of the invention have been described, it is not intended that the invention be limited thereto, as it is intended that the invention be as broad in scope as the art will allow and that the specification be read likewise. Thus, while the invention has been described with reference to gigabit ETHERNET, it will be appreciated that the invention could be applied to ETHERNET links of different bandwidth as well. In addition, while particular types of modified MAC frames have been disclosed, it will be understood other types of modified MAC frames might be able to obtain similar results. It will therefore be appreciated by those skilled in the art that yet other modifications could be made to the provided invention without deviating from its spirit and scope as claimed.

1. Method for multiplexing multiple signal streams over a single ETHERNET link, comprising:
receiving PDUs (protocol data units) from multiple streams at a first MAC (media access control) client;
encapsulating each PDU in a MAC frame which includes an identification of the stream to which the PDU belongs; and
transmitting the MAC frames over an ETHERNET link to a second MAC client.

2. The method according to claim 1, further comprising:
receiving the MAC frames at the second MAC client;
decapsulating each PDU; and
forwarding each PDU to a port associated with the stream identified in the MAC frame from which the PDU was decapsulated.

3. The method according to claim 1, wherein:
each MAC frame includes a pre-pended address field which identifies the stream with which the encapsulated PDU is associated.

4. The method according to claim 1, wherein:
the identification is mapped onto an IEEE 802.1Q VLAN (virtual local area network) tag within the MAC frame.

5. The method according to claim 2, wherein:
the identification is an IEEE 802.1Q VLAN (virtual local area network) tag within the MAC frame which is mapped to a port.

6. The method according to claim 2, wherein:
said forwarding each PDU to a port includes forwarding each PDU to a buffer associated with a port.

7. An apparatus for multiplexing multiple signal streams over a single ETHERNET link, comprising:
a first MAC (media access control) client; and
a second MAC client coupled to said first MAC client by the ETHERNET link,
said first MAC client having
means for receiving PDUs (protocol data units) from multiple streams,
means for encapsulating each PDU in a MAC frame which includes an identification of the stream to which the PDU belongs, and
means for transmitting the MAC frames over the ETHERNET link to said second MAC client.

8. The apparatus according to claim 7, wherein:
said second MAC client includes
means for receiving the MAC frames transmitted by said first MAC client;
means for decapsulating each PDU; and
means for forwarding each PDU to a port associated with the stream identified in the MAC frame from which the PDU was decapsulated.

9. The apparatus according to claim 7, wherein:
each MAC frame includes a pre-pended address field which identifies the stream with which the encapsulated PDU is associated.

10. The apparatus according to claim 7, wherein:
the identification is mapped onto an IEEE 802.1Q VLAN (virtual local area network) tag within the MAC frame.

11. The apparatus according to claim 8, wherein:
the identification is an IEEE 802.1Q VLAN (virtual local area network) tag within the MAC frame which is mapped to a port.

12. The apparatus according to claim 8, wherein:
said second MAC client includes a plurality of buffers, each associated with a port, and
said means for forwarding each PDU to a port includes means for forwarding each PDU to a buffer associated with a port.

13. An apparatus for multiplexing multiple signal streams over a single ETHERNET link, comprising:
a first MAC (media access control) client; and
a second MAC client coupled to said first MAC client by the ETHERNET link,
said first MAC client having
at least one buffer coupled to a source of PDUs (protocol data units) from multiple streams,
an addressing and scheduling module coupled to said at least one buffer, said addressing and scheduling module encapsulating each PDU in a MAC frame which includes an identification of the stream to which the PDU belongs, and
a MAC transmitter coupled to said addressing and scheduling block and to the ETHERNET link, said MAC transmitter transmitting the MAC frames over the ETHERNET link to said second MAC client.

14. The apparatus according to claim 13, wherein:
said second MAC client includes
a MAC receiver coupled to said ETHERNET link, said MAC receiver receiving the MAC frames transmitted by said first MAC client,
a receive addressing module coupled to said MAC receiver, said receive addressing module decapsulating each PDU, and
a plurality of port buffers coupled to said receive addressing module, each port buffer being associated with the stream identified in the MAC frame from which the PDU was decapsulated.

15. The apparatus according to claim 13, wherein:
each MAC frame includes a pre-pended address field which identifies the stream with which the encapsulated PDU is associated.

16. The apparatus according to claim 13, wherein:
the identification is mapped onto an IEEE 802.1Q VLAN (virtual local area network) tag within the MAC frame.

17. The apparatus according to claim 14, wherein:
the identification is an IEEE 802.1Q VLAN (virtual local area network) tag within the MAC frame which is mapped to a port.

18. The apparatus according to claim 14, wherein:
said second MAC client includes a plurality of buffers, each associated with a port, and
said means for forwarding each PDU to a port includes means for forwarding each PDU to a buffer associated with a port.
